(19) United States
(12) Patent Application Publication
(10) Pub. No.: US 2018/0214892 A1
(43) Pub. Date: Aug. 2, 2018

(54) Electro-Kinetic Separation of Solid Particles from Alkylated Aromatics

(71) Applicant: ExxonMobil Chemical Patents Inc., Baytown, TX (US)

(72) Inventors: Bhupender S. Minhas, Bridgewater, NJ (US); Anita S. Lee, The Woodlands, TX (US); Ivy D. Johnson, Lawrenceville, NJ (US); Kyle G. Lewis, Houston, TX (US); Michael F. Raterman, Doylestown, PA (US)

(21) Appl. No.: 15/863,432

(22) Filed: Jan. 5, 2018

Related U.S. Application Data
(60) Provisional application No. 62/452,599, filed on Jan. 31, 2017.

(51) Int. Cl. B03C 5/00; B01D 35/06; C10G 32/02

(52) U.S. Cl. CPC B03C 5/00; C10G 32/02; B01D 35/06

(57) ABSTRACT

Electro-kinetic separation processes for removing solid particles from alkylated aromatic process streams are provided herein.

### PRIORITY CLAIM

This application claims the benefit of Provisional Application No. 62/452,599, filed Jan. 31, 2017, the disclosure of which is incorporated herein by reference.

### FIELD OF THE INVENTION

This invention relates to electro-kinetic separation processes for removal of solid particles from process streams comprising alkylated aromatics, such as alkylated naphthalenes.

### BACKGROUND OF THE INVENTION

Lubricants in commercial use today are prepared from a variety of natural and synthetic base stocks admixed with various additive packages and solvents depending upon their intended application. One category of base stocks, Group V base stocks, which are synthetic base stocks, find application in automotive and industrial lubricant formulations. Group V base stocks are often incorporated into lubricant formulations to improve the solubility of additives, improve deposit performance, reduce volatility, and/or enhance the thermal-oxidative stability of the lubricant. Examples of Group V base stocks include alkylated aromatics (e.g., alkylated naphthalenes).

Manufacturing such alkylated aromatics generally involves reacting an aromatic reactant (such as naphthalene or a derivative thereof) with an alkylation agent (e.g., an olefin) in the presence of an alkylation catalyst in an alkylation reactor. The alkylation catalyst can take the form of a solid acid. The process stream exiting the alkylation reactor can contain, in addition to the desired alkylated aromatics, solid particles originating from the alkylation catalyst, the reactor equipment, and the reactants. Solid particles, even if contained in the alkylated aromatic product at a low concentration, can be detrimental to the performance of the end product, if not reduced to an acceptable level. For example, it is known that solid particles contained in a lubricant base stock, if at an unacceptable level, can cause visual haziness or cloudiness of the final lubricant composition formulated from the base stock, increase deposit formation in the lubricant, decrease filterability of the lubricant, reduce its lubricating efficacy, and increase surface corrosion and surface wear of the lubricated components, leading to shortened life span of the lubricant and higher risk of premature failure or higher energy consumption of the lubricated equipment.

Historically, the particle-containing alkylated aromatics process stream is passed through one or more stages of mechanical filtration to at least partially remove the solid particles contained therein. Mechanical filtration may involve passing the reaction product through a porous membrane with pores that are small enough to exclude a portion of the solid particles. However, the filtration rate can be negatively impacted by various factors, such as the viscosity of the reaction product, the amount of solids to be removed, and/or the morphology of the solids. Porous membrane filtration often requires the use of a filtration aid, typically in the form of diatomaceous earth, which forms a layer on the membrane filter to help collect solids that would otherwise bypass or clog the filter. After filtration, the filtration aid together with the solid particles in the process stream form a “filter cake” on the surface of the membrane filter. This cake will have absorbed liquid product from the product stream. Direct disposal of the filter cake with the absorbed liquid product is wasteful, while reclamation of the absorbed liquid product requires additional materials and steps. The compromise between particle filtration speed and degree of partial removal results in at least a portion of the solid particles, especially those having a particle size smaller than the pore size of the membrane, passing through the membrane and become entrained in the process stream after filtration.

### SUMMARY OF THE INVENTION

It has been found that electro-kinetic separation (“EKS”) can be used to effectively reduce solid particles, even those with exceptionally small size, from alkylated aromatics process streams without the need of a filtration aid. The EKS media laden with collected solid particles can be conveniently regenerated in-situ or ex-situ to reclaim utilized particle-abatement capacity of the EKS. Moreover, the solid particles thus removed by an EKS can be conveniently recycled to the upstream alkylation reactor, thereby increasing production capacity of alkylated aromatics per unit loading of the alkylation catalyst.

Thus, in one aspect, the present invention provides a process for treating a liquid process stream comprising an alkylated aromatic and solid particles. The process comprises removing at least a portion of the solid particles from the process stream by passing the process stream through at least one electro-kinetic separator (EKS).

In another aspect, the present invention provides a process for treating a liquid process stream comprising a hydrocarbon and solid particles, the process comprising removing at least a portion of the solid particles from the process stream by passing the process stream through at least one electro-kinetic separator.

Other embodiments, including particular aspects of the embodiments summarized above, will be evident from the detailed description that follows.

### BRIEF DESCRIPTION OF THE DRAWINGS

The drawings described herein are for illustrative purposes only of selected embodiments and not all possible implementations, and are not intended to limit the scope of the present disclosure.

FIG. 1 schematically illustrates a solid particle abatement process 101 in the prior art without using an EKS.

FIG. 2 schematically illustrates an exemplary solid particle abatement process 201 using an EKS according to the present disclosure.

FIG. 3 schematically illustrates an alternative solid particle abatement process 301 using an EKS according to the present disclosure.

FIGS. 4a and 4b schematically illustrate an EKS comprising a fabric EKS media (“EKS-1”) operating in the cleaning mode.

FIG. 5 schematically illustrates an EKS comprising glass beads as the EKS media (“EKS-2”) operating in the cleaning mode.

Corresponding reference numerals indicate corresponding parts throughout the several views of the drawings.

### DETAILED DESCRIPTION OF THE INVENTION

### I. Definitions

The term “and/or” as used in a phrase such as “A and/or B” herein is intended to include “A and B”, “A or B”, “A”, and “B”.

As used herein, the phrase “at least a portion of” means any meaningful portion above zero to the entirety of the object to which the phrase refers. Thus, for example, a portion of a composition or a stream can range from c1% to c2% thereof, based on the entirety quantity thereof, where c1 and c2 can be, independently, 0.1, 0.2, 0.4, 0.5, 0.6, 0.8, 1, 2, 4, 5, 6, 8, 10, 15, 20, 25, 30, 35, 40, 45, 50, 55, 60, 65, 70, 75, 80, 85, 90, 95, 96, 97, 98, 99, 100, as long as c1<c2.

As used herein, and unless otherwise specified, the term “alkyl” refers to a saturated hydrocarbon radical having from 1 to 1000 carbon atoms (i.e. C₁-C₁₀₀₀ alkyl), preferably from 1 to 500, from 1 to 300, from 1 to 200, from 1 to 100, from 1 to 80, from 1 to 60, from 1 to 50, from 1 to 30, or from 1 to 20, carbon atoms. Examples of alkyl groups include, but are not limited to, methyl, ethyl, propyl, butyl, pentyl, hexyl, heptyl, octyl, decyl, and so forth. The alkyl group may be linear, linear branched, cyclic, or substituted cyclic.

As used herein, and unless otherwise specified, the term “aromatic” refers to an unsaturated organic compound comprising an aromatic ring in structure thereof, the aromatic ring having a delocalized conjugated π system and preferably having from 4 to 20 carbon atoms. Exemplary aromatics include, but are not limited to, benzene, toluene, xylenes, mesitylene, ethylbenzenes, cumene, naphthalene, methylnaphthalene, dimethylnaphthalenes, ethylnaphthalenes, acenaphthalene, anthracene, phenanthrene, tetraphene, naphthacene, benzanthracenes, fluoranthrene, pyrene, chrysene, triphenylene, and the like, and combinations thereof. The aromatic may optionally be substituted, e.g., with one or more alkyl group, alkoxy group, halogen, etc. The aromatic ring may comprise one or more heteroatoms. Examples of heteroatoms include, but are not limited to, nitrogen, oxygen, and sulfur. Aromatics with one or more heteroatom in the aromatic ring therein include, but are not limited to: furan, benzofuran, thiophene, benzothiophene, oxazole, thiazole and the like, and combinations thereof. The aromatic ring may be monocyclic, bicyclic, tricyclic, other polycyclic, and may take the form of fused rings.

As used herein, the term “olefin” refers to an unsaturated hydrocarbon compound having a hydrocarbon chain containing at least one carbon-to-carbon double bond in the structure thereof, wherein the carbon-to-carbon double bond does not constitute a part of an aromatic ring. The olefin may be straight-chain, branched-chain, cyclic, or substituted cyclic. “Olefin” is intended to embrace all structural isomeric forms of olefins, unless it is specified to mean a single isomer or the context clearly indicates otherwise.

As used herein, the term “Cm olefin” means an olefin comprising carbon atoms per molecule in the number of integer m. The term “Cm-Cn olefin” means an olefin comprising carbon atoms per molecule in the range from m to n, where m and n are integers and m<n. Thus, a C10-C30 olefin is an olefin comprising carbon atoms per molecule in the range from 10 to 30.

An “alkylated” compound herein refers to a derivative of a compound, which comprises the basic structure of the compound and an alkyl group attached thereto.

As used herein, the term “alkylated aromatics” refers to a derivative of an aromatic compound, which comprises the basic structure of the aromatic compound and one or more alkyl group attached thereto. Thus, the structure of an alkylated aromatic can be schematically represented by the following formula:

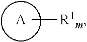

where the ring A represents the aromatic ring structure of the aromatic compound (e.g., substituted or unsubstituted naphthalene, benzene, biphenyl, and the like), R′, the same or different at each occurrence, represents a linear or branched, substituted or unsubstituted alkyl group directly connected to ring A, and m is an integer representing the number of the alkyl groups R¹ attached to ring A.

“Mechanical filtration” herein refers to a filtration process for separating a solid matter from a solid/fluid mixture effected only through traditional mechanical forces resulting from gravity, centrifugation, pressure gradient (vacuum or positive pressure), and the like, and combinations thereof, without intentionally exerting an external force to the solid matter to be separated from a liquid by an electric field. A rotary drum filter assisted with vacuum is a widely used mechanical filtration device for separating solids from liquids.

### II. Processes for Solid Particle Abatement from Alkylated Aromatics

The process of the present invention are particularly advantageous for removing solid particles, particularly catalyst solid particles, entrained in liquid process streams comprising alkylated aromatics. As such, description of the present invention will focus on treatment of such alkylated aromatics-containing process stream. However, to the extent other liquid process streams, such as liquid streams containing other hydrocarbons, whether aliphatic, aromatic or mixture of both, contain solid particles in need of abatement, use of the process of the present invention utilizing EKS is also contemplated.

U.S. Pat. No. 5,177,284 describes processes for making alkylated naphthalenes. U.S. Pat. Nos. 5,171,915 and 5,750,480 describe processes for making alkylated aromatics based on phenol and phenol derivatives. The contents of these references are incorporated herein by reference in their entirety.

Manufacture of alkylated aromatics often involves reacting an aromatic reactant (e.g., naphthalene, biphenyl, benzene, or analogues thereof) with an alkylating agent (e.g., an olefin) in the presence of an alkylation catalyst in an alkylation reactor operated under desirable alkylation conditions. The reaction mixture inside the reactor can be a single or multi-phase mixture comprising one or more materials in liquid phase, one or more materials in gas phase, and/or one or more materials in solid phase. Reactions can take place in any phase, or at the boundaries of multiple phases. The reaction mixture exiting the reactor as the process stream may contain a mixture of various isomers of mono-alkylated, di-alkylated, and even tri-alkylated aromatics at different concentrations. Typically, the added alkyl group is desirably attached to the aromatic ring of the aromatic reactant directly.

The alkylation catalyst can be desirably an acid capable of catalyzing the substitution of a hydrogen (or other group) on an aromatic ring structure with an alkyl group. The alkylation catalyst can be advantageously a solid acid. Other examples include solid Lewis acid catalysts, acid clays, polymeric acidic resins, amorphous solid catalysts, such as silica-alumina, and heteropoly acids, such as those containing both tungsten and zirconium, tungsten molybdates, tungsten vanadates, phosphotungstates and molybdotungstovanadogermanates.

Other examples of suitable solid acid alkylation catalysts include molecular sieves, such as synthetic or natural zeolites. For example, the acid catalyst may comprise a molecular sieve having a framework structure selected from the group consisting of BEA, EUO, FAU, FER, HEU, MEL, MFI, MOR, MRE, MTW, MTT, MWW, OFF, and combinations thereof. Examples of molecular sieve materials having such a framework structure include, but are not limited to: ZSM-5, ZSM-11, ZSM-12, ZSM-23, ZSM-35, ZSM-48, ZSM-50, Zeolite Beta, MCM-56, MCM-22, MCM-36, MCM-49, zeolite Y, zeolite X, and combinations thereof.

The solid acid catalyst can be advantageously installed in the alkylation reactor as a bed of catalyst in a fixed-bed reactor, and/or as particles suspended or carried in the liquid and/or gas reaction mixture. The flow of the reaction mixture in contact with the solid acid catalyst enables the alkylation reactions that produce a process stream exiting the alkylation reactor containing the various alkylated aromatic compounds, unreacted aromatics reactant, byproducts, and often, solid particles. As discussed above, the contents of the solid particles are desirably abated to a degree such that the final alkylated aromatics fluid can be used as a safe, efficient, and durable base stock for lubricant formulations or in other applications.

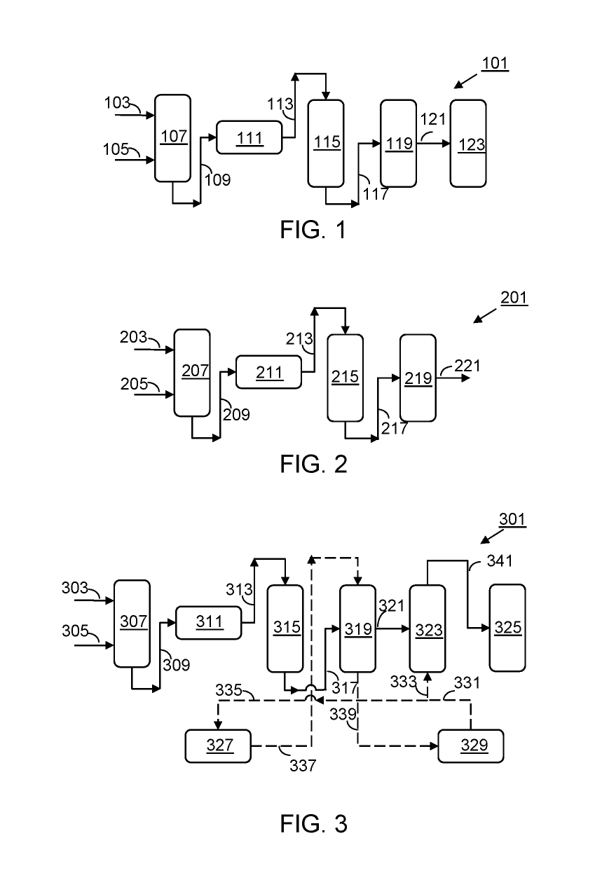

As shown in FIG. 1, a known process 101 for abating solid particles from an alkylated aromatics process stream involves the use of conventional mechanical filtration only. In FIG. 1, a feed aromatics stream 103 and a feed olefin stream 105 are supplied to alkylation reactor 107 which houses a solid acid catalyst bed (not shown). On contact with the solid acid catalyst, alkylated aromatics are produced. As a result, the crude reaction mixture process stream 109 exiting the alkylation reactor 107 may contain, in addition to desired alkylated aromatics, solid particles originating from the solid acid catalyst bed, the reactor equipment, and the feed streams 103 and 105. Process stream 109 may be cooled or heated to a predetermined filtration temperature in a suitable cooling/heating system 111. The process stream 113 at the desired temperature supplied from heating/cooling system 111, together with a filtration aid (such as diatomaceous earth, not shown) may be passed through a mechanical filter 115 to produce a stream 117 with reduced amount of solid particles. Additionally, the clean reaction product stream 117 may be passed through a distillation column 119 to remove unreacted olefins or aromatics therefrom to obtain a purified alkylated aromatics product stream 121, which can be delivered to the next vessel 123 in the system. Time, equipment, and process conditions required for filtration to the desired level of particle count can be affected by many factors, including but not limited to, viscosity of the process stream, the amount of solid particles to be removed, and the quantity and type of filtration aid used. The filtration aid and the solid particles intended for removal typically accumulate in the mechanical filter to form a “filter cake,” which also contains a liquid mixture of the desired product, unreacted aromatic reactant, and the like. The filter cake can be disposed of directly together with the liquid contained therein, resulting in waste of a portion of the desired product and unreacted reactant. Alternatively, the filter cake can be washed using a washing fluid to reclaim the liquid entrained therein. Because the mechanical filtration equipment and process stipulate the use of a filtration membrane with a limited pore size, it is possible that even after multiple stages of mechanical filtration, certain solid particles, especially those with size smaller than the pores of the filtration membrane, cannot be removed completely.

### III. The EKS and Process Using the EKS

Thus, the present disclosure addresses such problems by providing a solid particle abatement process for alkylated aromatics using an electro-kinetic separator device (“EKS”). For purposes of this disclosure, “electro-kinetic” and “electrostatic” are used interchangeably. In this discussion, electrostatic separation is defined as a filtration process that captures solid particles entrained in a liquid-containing fluid stream according to electrostatic principles and produces an alkylated aromatic product stream with reduced solid particle counts. The separation is performed by applying an electrical voltage to electrodes that are separated by a dielectric medium, creating an electric field. A direct current (DC) or alternating current (AC) voltage may be applied to the electrodes. Process fluid flows through the resulting electric field. As a result of the Coulomb's Law, solid particles, such as catalyst particles, bearing an electrical charge or polarized electric charge distribution, can move in desirable directions in the electric field, attach to the dielectric medium and become immobilized. The net result is the process stream exiting the EKS contains a reduced amount of solid particles.

The alkylated aromatics-containing process stream treated by the process of the present invention may comprise alkylated aromatics in quantities in a range from c1 wt % to c2 wt %, based on the total weight of the process stream entering the EKS, where c1 and c2 can be, independently, 50, 55, 60, 65, 70, 75, 80, 85, 90, 95, 96, 97, 98, or 99, as long as c1<c2.

The alkylated aromatics-containing process stream treated by the process of the present invention may comprise unreacted aromatics and unreacted alkylating agent(s) in combined quantities of c3 wt % to c4 wt %, based on the total weight of the process stream entering the EKS, where c3 and c4 can be, independently, 1, 2, 3, 4, 5, 10, 15, 20, 25, 30, 35, 40, as long as c3<c4.

The fresh process stream supplied from an immediately upstream equipment and entering the EKS may comprise solid particles in a concentration as measured by ASTM-D4807-5 in a range from p1 ppmw (parts per million by weight) to p2 ppmw, based on the total weight of the fresh process stream entering the EKS, where p1 and p2 can be, independently: 1,000; 2,000; 3,000; 4,000; 5,000; 6,000; 7,000; 8,000; 9,000; 10,000; 12,000; 14,000; 15,000; 16,000; 18,000; 20,000; 22,000; 24,000; 25,000; 26,000; 28,000; 30,000; as long as p1<p2.

A great majority of the solid particles contained in the process stream treated by the process of the present invention may be derived from the solid catalyst used in the alkylation reactor. For example, the percentage by weight of the solid particles in the fresh process stream entering the EKS supplied from an upstream equipment, based on the total weight of the solid particles entrained in the fresh process stream, can be in the range from a1% to a2%, where a1 and a2 can be, independently, 80, 85, 90, 95, 96, 97, 98, 99, 100, as long as a1<a2. The solid particle may contain a filtration aid, such as a diatomaceous earth.

The solid particles may have an average particle size of from about 1 to 1000 micrometer (μm) measured by using ASTM D7596-14.

In certain variations, the temperature of the process stream may be adjusted to a desirable level by a heat exchanger before entering the EKS. For example, as shown in FIG. 2, process stream 209 produced from feed aromatics stream 203 and feed alkylation agent (e.g., an olefin) stream 205 in alkylation reactor 207 in the presence of a solid-state alkylation catalyst (not shown) may be passed through a heat exchanger 211 to produce a temperature-adjusted stream 213. The process stream 213 may have a temperature in a range from T1 to T2° F., where T1 and T2 can be, independently, 300, 290, 280, 270, 260, 250, 240, 230, 220, 210, 200, 190, 180, 170, 160, 150, 140, 130, 120, 110, 100, 90, 80, 70, 60, or even 50, as long as T1<T2. Desirably, the process stream has a temperature higher than T3° C., where T3 can be 200, 180, 160, 150, 140, 120, 100, 90, or 80. Desirably, the heat exchanger 213 reduces the temperature of stream 209 to obtain the stream 213 having a temperature at least T4° C. lower than stream 209, where T4 can be, e.g., 10, 15, 20, 25, 30, 35, 40, 45, 50, 55, 60, 70, 80, 90, 100. The process stream 213 optionally may be passed to a filter feed tank 215 where it is stored, before being introduced into EKS 219 to produce an alkylated aromatic product stream 221 with abated solid particle count.

It is also contemplated that the process stream entering the EKS can have a relatively high temperature, especially where the alkylated aromatics have a high molecular weight requiring a relatively high processing temperature, in the range from T3 to T4° F., where T3 and T4 can be, independently, 200, 220, 240, 250, 260, 280, 300, 350, 400, 450, 500, 550, 600, as long as T3<T4.

The fresh process stream supplied to the EKS (the “fresh feed stream”) can comprise a filtration aid for the purpose of conglomerating the very fine solid particles contained therein, much similar to the filtration aids used in processes using only conventional mechanical filtration. A preferred example of the filtration aid is diatomaceous earth. The EKS can be used in combination with a traditional mechanical filtration device. In such embodiments, the EKS is preferably located downstream of at least one mechanical filtration device, although it is possible to locate the EKS upstream. The EKS has the ability of capturing very fine particles that have passed through the filter membrane of a mechanical filtration device without the need of additional filtration aid, hence the advantage of placing an EKS downstream a traditional mechanical filtration device. While in certain situations, it may be desirable to use a special filtration aid to facilitate the particle abatement through an EKS, it is envisioned that the use of an EKS can at least reduce the quantity of filtration aid used compared to conventional particle abatement processes without using an EKS at all. It is possible that a process uses EKS for particle abatement only, eliminating the need of any filtration aid otherwise required by conventional mechanical filtration devices.

The EKS comprises at least two electrodes made of electrical conductors capable of conducting electricity at the operating conditions. The electrodes can be made of any such conductors, such as carbon, silicon, metals and metal alloys (e.g., aluminum, copper, silver, gold, and other precious metals, conductive ceramics, and the like).

During operation, a voltage is applied to the electrodes, creating an electric field between them. The process stream is allowed to pass through the electric field, typically in a direction intercepting the electric field. Solid particles bearing electrical charges are forced to travel in the electric field as a result of Coulomb force exerted thereto. Neutral solid particles can be induced to become electrically polarized in the electric field, and then move in certain direction as a result of Coulomb force.

The amplitude of the voltage applied and the characteristics of the voltage profile (e.g., constant DC, alternating sinusoid, alternating flat pulses, or other profiles), the type of electrode material, shape, dimension, and position of the electrodes, as well as the distance between the electrodes, can be chosen by one skilled in the art to meet the need of the specific process of the invention, flow rate of the fresh feed stream, operating temperature, particle concentration in the fresh feed stream, number of EKS used, particle concentration required for the stream passed on to the downstream equipment, recycle ratio (discussed below), and the like.

It is highly desirable that the process stream is a poor electrical conductor under the operating conditions. Thus, any electric current flowing through the process stream during operation of the EKS is desirably negligible, and upstream and downstream equipment are not electrified to an unsafe level through the process stream in direct contact with the electrodes.

While the process stream can directly contact the electrodes applying the electric field, it is contemplated that a dielectric barrier can be installed between the electrodes and the process stream, especially if a high voltage is applied between the electrodes, and/or the process stream has a high conductivity which can result in large currents if direct contact between the process stream and the electrodes is allowed.

Further, as described above, the EKS may comprise a dielectric medium (the “EKS media”) disposed between the electrodes applying the electric field. Suitable EKS media contemplated herein include any solid material that has a low electrical conductivity under the operating conditions of the EKS. Preferably, the EKS media has an electrical conductivity lower than the electrode material. Preferably, the EKS media has an electrical conductivity lower than the process stream fluid under the operating conditions. Non-limiting examples of suitable EKS media include fibers, fabrics (e.g., non-woven or woven cellulose and the like), flakes, foams, meshes, pellets (such as beads) made of materials such as glass, ceramic, glass-ceramic, inorganic oxides, cellulosic materials such wood, and combinations and mixtures thereof. In one embodiment, the EKS media may be fabric. The fabric may at least partially form channels of any suitable geometry through which the process stream fluid may flow. While the process stream flow through the channels and the electric field, solid particles can be attracted to the fabric, adhere to the fabric, and collected on the fabric, without being carried to the downstream equipment, to achieve the particle abatement effect.

In various aspects, the EKS can be operated at a pressure of about 100 kPaa (kilopascal absolute pressure) to about 3500 or about 100 kPaa to about 3000 kPaa, or about 100 kPaa to about 2500 kPaa, or about 100 kPaa to about 2000 kPaa, or about 100 kPaa to about 1500 kPaa, or about 100 kPaa to about 1000 kPaa, or about 100 kPaa to about 500 kPaa, or about 250 kPaa to about 3500 kPaa, or about 250 kPaa to about 3000 kPaa, or about 250 kPaa to about 2500 kPaa, or about 250 kPaa to about 2000 kPaa, or about 250 kPaa to about 1500 kPaa, or about 250 kPaa to about 1000 kPaa, or about 250 kPaa to about 500 kPaa, or about 500 kPaa to about 3500 kPaa, or about 500 kPaa to about 3000 kPaa, or about 500 kPaa to about 2500 kPaa, or about 500 kPaa to about 2000 kPaa, or about 500 kPaa to about 1500 kPaa, or about 500 kPaa to about 1000 kPaa.

As discussed herein, the treated alkylated product stream exiting the EKS has a reduced content of particles compared to the fresh feed stream entering the EKS. In various aspects, the treated alkylated product stream may comprise solid particles in a concentration, as measured by ASTM D4807-05, of less than about 10,000 ppmw (parts per million by weight), less than about 7,500 ppmw, less than about 5,000 ppmw, less than about 2,500 ppmw, less than about 1,000 ppmw, less than about 750 ppmw, less than about 500 ppmw, less than about 250 ppmw, less than about 100 ppmw, less than about 75 ppmw, less than about 50 ppmw, less than about 25 ppmw, less than about 10 ppmw, less than about 1.0 ppmw, or less than about 0.50 ppmw or about 0.010 ppmw, based on the total weight of the process fluid exiting the EKS. Additionally or alternatively, the treated alkylated product stream may comprise solid particles in a concentration of about 0.010 ppmw to about 10,000 ppmw, about 0.010 ppmw to about 5,000 ppmw, about 0.010 ppmw to about 1,000 ppmw, about 0.010 ppmw to about 100 ppmw, about 0.010 ppmw to about 50 ppmw, about 0.010 ppmw to about 10 ppmw, or about 0.010 ppmw to about 1.0 ppmw.

The EKS can be advantageously used for process streams containing solid particles that have small sizes, such as those having an average particle size of at most 1000 micrometer (μm), such as at most: 700 μm, 600 μm, 500 μm, 400 μm, 300 μm, 200 μm, 100 μm, 80 μm, 60 μm, 50 μm, 40 μm, 20 μm, 10 μm, 9 μm, 8 μm, 6 μm, 5 μm, 4 μm, 3 μm, or 5 μm.

### Regeneration of the EKS Media

As the process stream flows through the EKS, the EKS media can reach a desired level of captured solid particles, such as any convenient amount up to the maximum capacity of the EKS media for capturing and retaining solids. This desired capacity of the EKS can be determined by many factors, including but not limited to the voltage profile applied to the electrodes, flow rate of the process stream, solid particle density and particle size distribution in the process stream, the type and capacity of the EKS media used for collecting solid particles, and the like.

When the EKS media reaches its particle collection capacity, it may be desirable to regenerate the EKS media to remove at least a portion of the collected solid particles from the EKS media, thereby reclaiming or restoring at least part of the capacity. One contemplated regeneration process includes removing the soiled EKS media from the EKS device, cleaning the media by using mechanical, chemical, electrical means, and combinations thereof, and re-installing the thus cleaned media into the EKS device. Solvents, detergents, flames, oxidizing agents, plasma, brushes, stirring device, flushing fluid streams, and the like, may be used for cleaning the soiled EKS media.

Preferably, however, an in-situ regeneration process is used, where the EKS media is allowed to remain in the EKS device during regeneration. During such in-situ regeneration process, supply of the process stream to the EKS may be turned off partly or completely, and voltage applied to the EKS electrodes may be reduced to zero or changed to a profile favorable for releasing captured solid particles so that they may be flushed out of the EKS. During in-situ regeneration of the EKS media, a process compatible fluid as a backwash fluid is passed through the EKS, whereby at least a portion of the solid particles collected in the media is flushed out. The process compatible fluid may be any suitable fluid (including liquids, gases and mixtures thereof), including but not limited to: an alkylated aromatics product stream, a stream of the aromatics fed to the alkylation reactor, a stream of the alkylation agent fed to the alkylation reactor, a stream of a mixture of the aromatics and alkylation agent, air, nitrogen, hydrocarbons (e.g., methane, ethane, butane, hexane, cyclohexane, and the like), solvents, or an aqueous liquid. Preferably, the process-compatible washing fluid is miscible with the process stream fluid.

Where an alkylated product stream is supplied to the EKS as a backwash fluid to remove at least a portion of the solid particles collected therein, at least about 1% to about 20% or about 5% to about 10% of the treated alkylated aromatic product stream may be recycled through the EKS to collect the deposited solid particles. After exiting the EKS, the backwash fluid can be further passed to a separation system (such as a mechanical filter, a setting tank, an EKS, or other separation devices) to remove solid particles therefrom. The thus reclaimed backwash fluid may be used for all suitable purposes.

FIG. 3 schematically illustrates a system comprising an EKS that can be operated in cleaning mode where a process stream passes through the EKS and cleaned, or alternatively, in regeneration mode where a cleaning/washing fluid is passed through the EKS to remove at least a portion of the solid particles collected and accumulated inside the EKS to reclaim at least a portion of the particle abatement capacity thereof. As shown in this drawing, a process stream 309 produced by the reaction of an aromatics feed (e.g., a naphthalene-containing liquid) stream 303 and an alkylation agent (e.g., a C₁₀-C₂₀ olefin) stream 305 in alkylation reactor 307 housing a solid acid catalyst bed (not shown) exits reactor 307. The process stream 309 contains desired alkylated aromatics (e.g., alkylated naphthalenes bearing long-chain alkyl groups connected to the naphthalene aromatic ring structure derived from the olefin), unreacted olefin and naphthalene, solid particles of the alkylation catalyst and possibly other materials, and byproducts. To abate the solid particles contained therein, stream 309 is temperature-adjusted to a suitable temperature by heating/cooling device 311 (e.g., a heat exchanger) to obtain a stream 313. An optional EKS feed tank 315 can be used for storing temperature-adjusted process stream 313 and supplying a stream 317 at suitable temperature to EKS 319. During cleaning mode (where back-wash fluid stream 337, in dashed line and described below, is turned off), process stream 317 is supplied to the EKS 319, where at least a portion of the solid particles are adsorbed by the EKS media to produce a treated stream 321 having an abated quantity of solid particles compared to stream 317. Optionally, the abated stream 321 may pass through a conventional mechanical filter (e.g., a vacuum rotary drum filter) to obtain a further treated stream 341 comprising solid particles at a further reduced concentration therein compared to stream 321. Stream 341 is then delivered to the next processing device 325. During in-situ regeneration, process stream 317 is turned off. Instead, a process-compatible back-wash fluid stream 337 (e.g., a stream of treated alkylated aromatics product, or a stream of a solvent, and the like) supplied from a process-compatible back-wash fluid supply tank 327, in dashed line, is introduced to the EKS 319, whereby at least a portion (preferably a majority, such as at least 50 wt %, 60 wt %, 70 wt %, 80 wt %, or even 90 wt %) of the solid particles collected in the EKS media is flushed out, and a solid particle-laden process-compatible back-wash fluid stream 339, in dashed line, is produced. As shown in FIG. 3, stream 339 may be introduced into a settling tank 329 (or other solid-liquid separation device) where the solid particles may settle to the bottom. After separation, a fluid stream 331 (in dashed line) containing solid particles at a concentration lower than in stream 339 may be obtained, which may be partly or completely recycled back to the process-compatible back-wash fluid tank 327 as stream 335 (in dashed line). The conventional mechanical filtration device 323 may desirably make use of a washing fluid stream to wash the filter cake to remove residual liquid entrained in the filter cake. In such case, additionally or alternatively, at least a portion of stream 331, shown as stream 333 (in dashed line) may be supplied to filter 323 as at least a portion of the washing fluid for removing residual liquid entrained in the filter cake.

Additionally or alternatively, instead of regenerating the EKS media, the EKS media may be replaced once the EKS media reaches a desired level of captured solid particles as described herein. For example, the EKS media may be replaced after one separation cycle, two separation cycles, three separation cycles, four separation cycles, or five separation cycles. For example, a first separation cycle can comprise passing a designated process stream volume through the EKS to produce the treated alkylated aromatic product stream and a second cycle can comprise passing at least a portion of the treated alkylated aromatic product stream through the EKS and so on. Alternatively, a first separation cycle can comprise passing a first designated process stream volume through the EKS to produce a first treated alkylated aromatic product stream and a second cycle can comprise passing a second designated process stream volume through the EKS to produce a second treated alkylated aromatic product stream. Preferably, however, a continuous fresh feed stream supplied from the equipment upstream the EKS is passed through the EKS to obtain an abated stream, which is then split into at least two streams, one of which is recycled to the EKS, and the other to the downstream equipment, which can be a downstream EKS, a distillation column, a storage unit, or other vessels. The ratio of the weight of the stream recycled to the EKS to the weight of the fresh feed stream entering the EKS can vary significantly depending on the particle concentration in the fresh feed stream entering the EKS, the efficiency and capacity of the EKS, and the desired particle concentration in the stream allowed to leave to the downstream equipment. Desirably, the recycle ratio can range from r1 to r2, where r1 and r2 can be, independently, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, as long as r1<r2. At a given EKS capacity and efficiency and all other process conditions held equal, the higher the recycle ratio, the lower the concentration of solid particles in the stream passed on to the downstream equipment will be.

It is noted that the configurations in FIGS. 2 and 3 schematically show the EKS as one unit. However, a plurality of EKS can be used, which are connected in parallel or in series, or in both fashions, to meet the solid particle abatement performance requirements of the process. Preferably, at least two of the multiple EKS are configured such that they are capable of being operated in parallel, i.e., both receiving fresh feed stream from the same upstream equipment. A system having the capability of operating multiple EKS units in parallel permits the possibility of operating one EKS in cleaning mode (i.e., a mode where fresh feed stream is accepted and a treated product stream is produced) and operating one EKS in regeneration mode or idling mode if needed, thus allowing for a steady and uninterrupted operation of the whole product manufacture system.

### Optional Further Steps

The present invention can be used in a system and process for making alkylated aromatics without the need of the use any filtration equipment other than the EKS. Alternatively, as discussed above, the EKS can be used in conjunction with other filtration equipment such as traditional mechanical filtration devices. While preferably the EKS is downstream of a conventional mechanical filter, it is contemplated that in certain situations, a mechanical filter may be installed and used downstream of an EKS. An upstream EKS can reduce the particle load applied to the downstream mechanical filter.

The processes described herein may also include steps of separating unreacted aromatic and/or unreacted olefin, and byproducts from the treated alkylated aromatic product stream. Such separation steps can be carried out in one or more distillation columns and/or strippers connected in series or in parallel, or both. The separated unreacted aromatics and unreacted olefins can be advantageously recycled to the alkylation reactor. After byproducts removal, the clean and purified alkylated aromatics product desirably having a low solid particle count, can be used for various applications, with or without additional treatment and with or without combination with other chemical agents, such as lubricant base stocks, heat transfer oil (e.g., transformer oil), process oil, power transfer fluid, and the like. Further, the alkylated aromatics may be used as an intermediate for making functionalized specialty chemicals with various applications.

The solid particles released form the EKS during regeneration process can be recycled to the alkylation reactor where appropriate. Thus, the wash stream containing the process-compatible back-wash fluid can be directly recycled to the alkylation reactor for that purpose, especially if the back-wash fluid contains primarily the alkylated aromatics product, the alkylating agent, the aromatics reactant, or combinations thereof. In certain situations, it may be desirable to separate the solid particles from the fluid in the wash stream in a settling tank or other devices, and then recycle a stream containing enriched solid particles at an elevated loading to the alkylation reactor. To the extent the solid particles collected by the EKS contain primarily those derived from the alkylation catalyst used in the alkylation reactor, recycling the particles released from the EKS to the alkylation reactor can be particularly advantageous. In alkylation reactions where filtration aids used for conventional mechanical filtration devices are undesirable, recycling the filter cake containing the catalyst particles and filtration aid produced from the filter is not desirable. Because the EKS can be operated without using a filtration aid, recycling the catalyst particles released from the EKS to those alkylation reactors can be carried out conveniently.

### EXAMPLES

Solid-particle-containing test fluids containing alkylated naphthalenes produced by alkylation of naphthalene in the presence of a solid acid catalyst were filtered/separated. The test fluids were measured for particle concentrations before and after filtration/separation. In inventive examples (Examples 1 and 2), the test fluids were filtered/separated by a single stage EKS system. In the comparative example (Example 3), the test fluid was filtered by a conventional mechanical filtration system using a rotary drum filter facilitated by a diatomaceous earth filtration aid.

Measurements of particle concentrations in the fluids were made pursuant to ASTM D4807-05. This method included heating an aliquot of the measured fluid sample between 1.0 and 50 mL in 10-fold excess toluene, which was then poured over a pre-weighted filter paper having a pore size of 0.8 μm or 1.2 μm. Solid particles captured on the filter paper were washed with toluene to remove any residual hydrocarbons (other than toluene). Subsequently, the filter paper was dried and then weighed for particle concentration determination.

### Example 1: Separation Using EKS with Fabric EKS Media

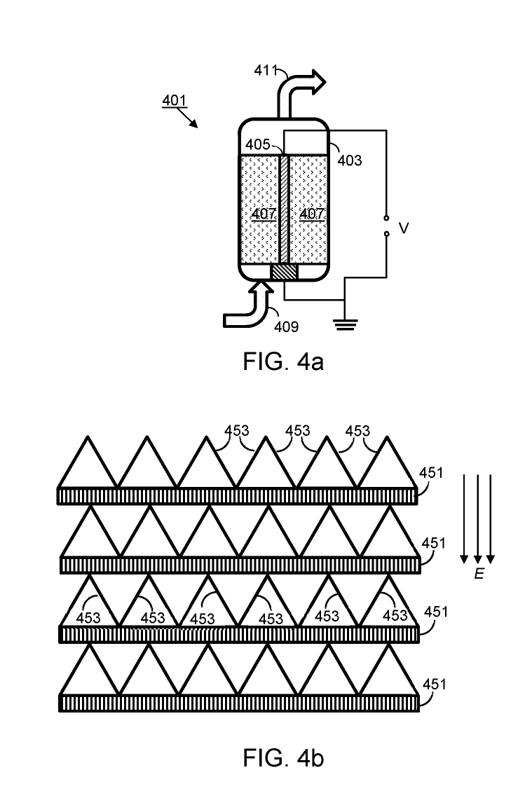

Two test fluids (“Feed 1” and “Feed 2”) were passed through a 4-liter EKS with fabric media and variable voltage and variable flow rate capability (Kleentek electrostatic oil conditioning system available from United Air Specialists Inc., Blue Ash, Ohio, United States, “EKS-1”). A schematic of EKS-1 in operation (401) is shown in FIG. 4a. EKS-1 comprises a stainless steel shell 403, which is grounded and serves as one of the two EKS electrodes. Inside shell 403, a longitudinal metal rod 405, electrically separated from the shell at the bottom, was installed as the opposing EKS electrode. A dielectric EKS media 407, made of nonwoven pleated fabric, was placed between the electrode 405 and the shell 403. During operation in the cleaning mode, a high voltage V is applied between electrode 405 and the shell 403, generating an electric field in the space between. Particle-laden stream of the feeds 409 was pumped into EKS-1 from the bottom and allowed to flow through the EKS media 407 and the electric field, and exit EKS-1 from the top as stream 411. FIG. 4b shows a schematic of a local structure of the fabric EKS media 407 comprising multiple fabric walls 451 and 453 defining fluid channels extending generally in the longitudinal direction along the desired upward stream flow direction. The stream flow direction in the media (not shown) in FIG. 4b is substantially perpendicular to the paper, while the direction of the electric field (“E”) is substantially perpendicular to the series of primary structural walls 451. While the local sections of walls 451 are shown as flat in FIG. 4b, in EKS-1, at the macroscopic, long range, they can be curved (e.g., forming a cylindrical sleeves enclosing the electrode 405 in the center thereof). During operation in the cleaning mode, at least a portion of the solid particles in the liquid stream 409 entering EKS-1, bearing electrical charges or induced partial electrical charges, move toward the fabric walls 451 and 453 as a result of the Coulomb force exerted by the electric field, contact and adhere to the fabric surface due to fabric surface micro-features and the Coulomb force, and become immobilized. The net effect is a reduced quantity of particles in stream 411 exiting EKS-1 compared to stream 409 entering EKS-1.

In the separation tests, Feed 1 and Feed 2 were separately pumped from a feed container into the shell of EKS-1. The outlet from the test cell returned back to the feed container, i.e., the feed was pumped in a recirculation mode. DC voltage was applied across electrode 405 and the shell 403. Liquid samples (Products 1a and 1b) with reduced solid particle content were taken from the feed container after a predetermined operation time. Feed 1, Feed 2, Product 1a and Product 1b were measured for solid particle concentrations. The results are shown in Table 1 below. EKS-1 reduced solid particles concentration from 15,000 ppmw in Feed 1 to 0.8 ppmw in Product 1a using a 1.2 μm filter and from 18,000 ppmw in Feed 2 to 10 ppmw in Product 1b using a 0.8 μm filter.

### Example 2: Separation Using EKS with Glass Bead Media

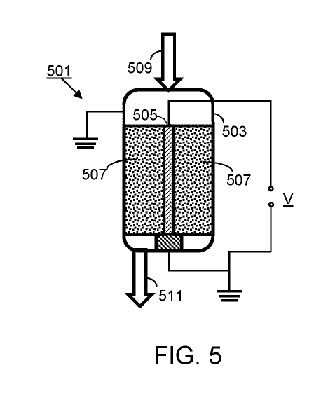

Two test fluids (“Feed 1” and “Feed 3”) were passed through an EKS with glass beads media (Gulftronic™ electrostatic separators available from General Atomics, 3550 General Atomics Court, San Diego, Calif. 92121-1122, United States, “EKS-2”). A schematic of EKS-2 in operation (501) is shown in FIG. 5. EKS-2 comprises a metal shell 503, which is grounded and serves as one of the two EKS electrodes. Inside shell 503, a longitudinal metal rod 505, electrically separated from the shell at the bottom, was installed as the opposing EKS electrode. A dielectric EKS media 507, made of a plurality of glass beads, was placed between the electrode 505 and the shell 503. During operation in the cleaning mode, a high voltage V is applied between electrode 505 and the shell 503, generating an electric field in the space between. Particle-laden stream of the feeds 509 was supplied into EKS-2 from the top and allowed to flow downwards through the EKS media 507 and the electric field, and exit EKS-2 from the bottom as stream 511. At least a portion of the solid particles entrained in the liquid stream 509 entering EKS-2, bearing electrical charges or induced partial electrical charges, move toward the shell 503 or electrode 505 as a result of the Coulomb force exerted by the electric field, contact and adhere to the surfaces of the glass beads due to surface micro-features and the Coulomb force, and become immobilized. The net effect is a reduced quantity of particles in stream 511 exiting EKS-2 compared to stream 509 entering EKS-2. Unlike EKS-1, EKS-2 does not include a pump for circulation, so the feeds (Feed 1 and Feed 3) were passed through in a single pass to produce products with reduced solid particle contents (Products 2a and 2b). Feed 1, Feed 3, Products 2a and 2b were measured for solid particle concentrations. The results are reported in Table 1 below. In a single pass EKS-2 reduced solid particle concentration from 15,000 ppmw in Feed 1 to 0.3 ppmw in Product 2a using a 1.2 μm filter and from 14,000 ppmw in Feed 3 to 40 ppmw in Product 2b using a 0.8 μm filter.

### Comparative Example 3: Separation Using Mechanical Filtration

Feed 1 was passed through a mechanical rotary drum filter to remove solid particles and to produce a treated product (“Comparative Product”), which was measured for solid particle concentration. Results are reported in Table 1 below.

TABLE 1

| | | Solid Particle |
|---|---|---|
| | Filter Pore Size | Concentration |
| Fluid | (μm) | (ppmw) |
| Feed 1 | Nominal manufacturing value | 15,000 |
| Product 1a | 1.2 | 0.8 |
| Product 2a | 1.2 | 0.3 |
| Feed 2 | 0.8 | 18,000 |
| Product 1b | 0.8 | 10 |
| Feed 3 | 0.8 | 14,000 |
| Product 2b | 0.8 | 40 |
| Comparative Product | 1.2 | 0.3 |

What is claimed is:

1. A process for treating a liquid process stream comprising an alkylated aromatic and solid particles, the process comprising removing at least a portion of the solid particles from the process stream by passing the process stream through at least one electro-kinetic separator (EKS).

2. The process of claim 1, wherein the process stream is produced from a reactor where an aromatic reactant reacts an alkylation agent in the presence of an alkylation catalyst at least partly in solid state to produce the alkylated aromatics.

3. The process of claim 2, wherein the alkylated aromatic comprises an alkylated naphthalene, and the alkylation catalyst comprises one or more of the following: solid acids, a solid oxide, a solid Lewis acid, an acid clay, a polymeric acidic resin, and a heteropoly acid.

4. The process of claim 3, wherein the aromatic reactant comprises nathphalene, and the alkylation agent comprises a C10-C30 olefin.

5. The process of claim 1, wherein the solid particles have an average particle size in the range from 1 to 1000 micrometers.

6. The process of claim 2, wherein at least 90 wt % of the solid particles are derived from the alkylation catalyst.

7. The process of claim 1, wherein the solid particles comprise particles derived from an alkylation catalyst, particles derived from the reactor equipment, and particles derived from post-reaction treatment before the EKS.

8. The process of claim 1, further comprising passing the process stream through one or more mechanical filtration systems before or after the EKS.

9. The process of claim 1, further including a step of reducing the temperature of the process stream by at least 10° C. before passing the process stream through the EKS.

10. The process of claim 1, wherein the process stream has a temperature of at least 100° C. when passing through the EKS.

11. The process of claim 1, wherein the EKS comprises:
at least two opposite electrodes with differing electrical potentials applying an electric field; and
an EKS media material disposed between the two electrodes,
wherein the EKS media is selected from fibers, fabrics, flakes, foams, meshes, pellets, and combinations thereof.

12. The process of claim 11, wherein the EKS media comprises a fabric.

13. The process of claim 12, wherein the process stream flows through a channel formed at least partially from the fabric.

14. The process of claim 11, wherein the EKS media is made from a material selected from inorganic glasses, ceramics, glass-ceramics, inorganic oxides, and mixtures and combinations thereof.

15. The process of claim 1, wherein at least a portion of the alkylated aromatic product stream exiting the EKS is recycled to the EKS.

16. The process of claim 11 further comprising a step of regenerating the EKS media.

17. The process of claim 16, wherein the step of regenerating the EKS media comprises washing the EKS media by recycling a portion of the process stream having exited the EKS to the EKS, thereby removing at least a portion of the particles collected in the EKS media.

18. The process of claim 16, wherein the step of regenerating the EKS media comprises washing the EKS media by using a process-compatible washing fluid to remove at least a portion of the particles collected in the EKS media.

19. The process of claim 18, wherein the process-compatible washing fluid is selected from the group consisting of air, nitrogen, a hydrocarbon containing liquid and combinations thereof.

20. A process for treating a liquid process stream comprising a hydrocarbon and solid particles, the process comprising removing at least a portion of the solid particles from the process stream by passing the process stream through at least one electro-kinetic separator (EKS).

21. The process of claim 20, wherein the liquid process stream is produced from a reactor containing a catalyst at least partly in solid state, and at least a portion of the solid particles in the liquid process stream are derived from the catalyst.
